(19) United States
(12) Patent Application Publication
(10) Pub. No.: US 2017/0031622 A1
(43) Pub. Date: Feb. 2, 2017

(54) METHODS FOR ALLOCATING STORAGE CLUSTER HARDWARE RESOURCES AND DEVICES THEREOF

(71) Applicant: NetApp, Inc., Sunnyvale, CA (US)

(72) Inventors: Rajesh Nagarajan, Chennai (IN); Kavish Shetty, Bangalore (IN)

(21) Appl. No.: 14/814,668

(22) Filed: Jul. 31, 2015

(51) Int. Cl. G06F 3/06; G06F 9/455

(52) U.S. Cl. CPC G06F 3/0631; G06F 3/0607; G06F 3/067; G06F 9/45558; G06F 2009/45583; G06F 2009/4557

(57) ABSTRACT

Methods, non-transitory computer readable media, and computing apparatus that obtain hardware resource data for storage node computing devices and generate a hardware resource pool based on the hardware resource data. The hardware resource pool and a hardware allocation table are updated based on an allocation of a portion of the hardware resources to each of the storage virtual machines. A determination is made when utilization of at least one of the allocated portions of the hardware resources exceeds a threshold level for one of the storage virtual machines. The hardware resource pool and the hardware allocation table are updated to modify the one of the portions of the hardware resources allocated to the one storage virtual machine based on the determination. Additionally, the hardware resource pool and hardware allocation table are maintained to reflect the addition and removal or storage virtual machines as well as storage node computing devices.

### FIELD

This technology relates to data storage cluster management and, more particularly, to methods and devices for allocating and managing hardware resources in a cluster of storage node computing devices.

### BACKGROUND

Data storage networks increasingly include high performance computing (HPC) devices, such as a cluster of symmetric multiprocessor (SMP) storage node computing devices. The storage node computing devices host storage virtual machines, or virtual servers, that manage data storage in the storage cluster on behalf of applications. These storage virtual machines have requirements for hardware resources, such as compute, memory, cache, and storage, for example, that vary based on the requirements of associated applications.

Currently, networking and storage components in a storage cluster can be statically allocated to the various storage virtual machines operating across the storage node computing devices of a storage cluster, and static allocation is not available for other hardware resources, such as processor, memory, and cache. Accordingly, some hardware resources in a storage cluster are often over-utilized or under-utilized by the storage virtual machines over time, resulting in inefficient utilization of the hardware resources.

### SUMMARY

A method for allocating storage cluster hardware resources includes obtaining, by a computing apparatus, hardware resource data for a plurality of hardware resources of a plurality of storage node computing devices of a storage cluster and generating a hardware resource pool based on the hardware resource data. The hardware resource pool and a hardware allocation table are updated, by the computing apparatus, based on an allocation of a portion of the hardware resource pool to each of the storage virtual machines. A determination is made, by the computing apparatus, when utilization of at least one of the allocated portions of the hardware resources exceeds a threshold level for one of the storage virtual machines. The hardware resource pool and the hardware allocation table are updated, by the computing apparatus, to modify the one of the portions of the hardware resources allocated to the one of the storage virtual machines, when the determining indicates the utilization exceeds the threshold level.

A non-transitory computer readable medium having stored thereon instructions for allocating storage cluster hardware resources comprising executable code which when executed by a processor, causes the processor to perform steps including obtaining hardware resource data for a plurality of hardware resources of a plurality of storage node computing devices of a storage cluster and generating a hardware resource pool based on the hardware resource data. The hardware resource pool and a hardware allocation table are updated based on an allocation of a portion of the hardware resource pool to each of the storage virtual machines. A determination is made when utilization of at least one of the allocated portions of the hardware resources exceeds a threshold level for one of the storage virtual machines. The hardware resource pool and the hardware allocation table are updated to modify the one of the portions of the hardware resources allocated to the one of the storage virtual machines, when the determining indicates the utilization exceeds the threshold level.

A computing apparatus includes a processor and a memory coupled to the processor which is configured to be capable of executing programmed instructions comprising and stored in the memory to obtain hardware resource data for a plurality of hardware resources of a plurality of storage node computing devices of a storage cluster and generating a hardware resource pool based on the hardware resource data. The hardware resource pool and a hardware allocation table are updated based on an allocation of the hardware resource pool to each of the storage virtual machines. A determination is made when utilization of at least one of the allocated portions of the hardware resources exceeds a threshold level for one of the storage virtual machines. The hardware resource pool and the hardware allocation table are updated to modify the one of the portions of the hardware resources allocated to the one of the storage virtual machines, when the determining indicates the utilization exceeds the threshold level.

This technology has a number of associated advantages including providing methods, non-transitory computer readable media, and devices that dynamically allocate additional hardware resources to storage virtual machines that are over-utilizing hardware resources and deallocate hardware resources from storage virtual machines that are under-utilizing hardware resources. With this technology, hardware resources of new storage node computing devices added to a cluster can be integrated dynamically via a hardware resource pool and without downtime. Additionally, storage virtual machines can be prioritized with respect to the allocation of hardware resources based on business requirements. Accordingly, this technology facilitates relatively efficient utilization of hardware resources in a storage cluster.

### BRIEF DESCRIPTION OF THE DRAWINGS

FIG. 1 a block diagram of a network environment with an exemplary storage cluster computing apparatus with exemplary storage node computing devices;

FIG. 2 is a block diagram of one of the exemplary storage node computing devices;

FIG. 3 is a flowchart of an exemplary method for initializing a storage cluster and managing the addition of storage virtual machines and storage node computing devices;

FIG. 4 is a flowchart of an exemplary method for dynamically allocating storage cluster hardware resources; and

FIG. 5 is a functional flow diagram of a method for allocating storage cluster hardware resources.

### DETAILED DESCRIPTION

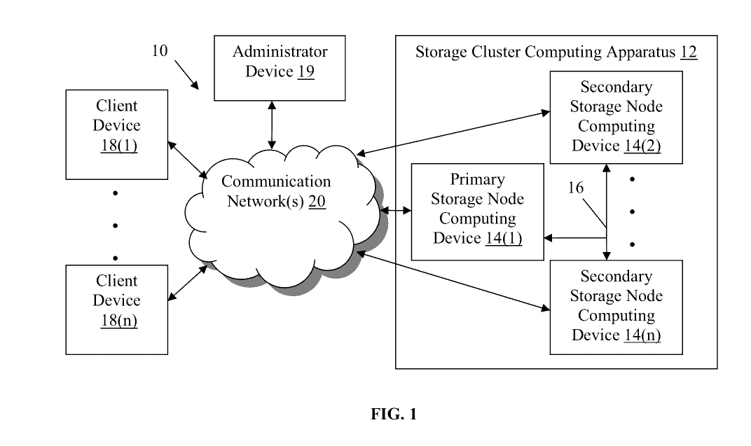

A network environment 10 including an example of a storage cluster 12 with storage node computing devices 14(1)-14(n) is illustrated in FIG. 1. The storage node computing devices 14(1)-14(n) in this particular example include a primary storage node computing device 14(1) and secondary storage node computing devices 14(2)-14(n), although any number of storage node computing devices with other designations can also be used. The storage node computing devices 14(1)-14(n) are coupled to each other by a cluster interconnect 16 and to client devices 18(1)-18(n) and an administrator device 19 by communication network(s) 20. In other examples, this environment 10 can include other numbers and types of systems, devices, components, and/or elements in other configurations. This technology provides a number of advantages including methods, non-transitory computer readable media, and devices that facilitates efficient utilization of available hardware resources in a storage cluster.

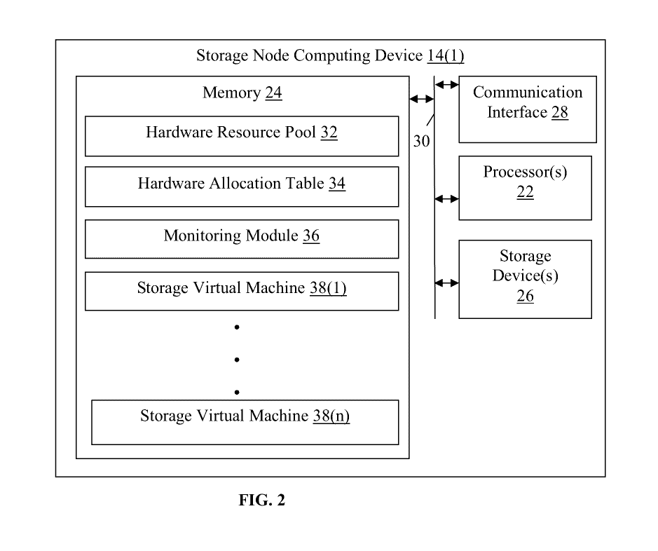

Referring to FIG. 2, a block diagram of one of the exemplary storage node computing device 14(1) is illustrated. In this example, since the other storage node computing devices 14(2)-14(n) have the same structure and operation as the exemplary storage node computing device 14(1), then for ease of illustration and description only exemplary storage node computing device 14(1) is shown. Additionally, one or more of the storage node computing devices 14(1)-14(n) could have other types and/or numbers of elements in other configurations and/or performing other types and/or numbers of other operations. Each of the storage node computing devices 14(1)-14(n) is generally configured to receive requests to write data to storage volumes hosted by the storage cluster 12 and to read data from storage volumes hosted by the storage cluster 12. Each of the storage node computing devices 14(1)-14(n) in this particular example include processor(s) 22, a memory 24, storage device(s) 26, and a communication interface 28, and which are all coupled together by a bus 30 or other communication link, although the storage node computing device 14 can have other types and numbers of components or other elements.

The processor(s) 22 of each of the storage node computing devices 14(1)-14(n) executes a program of stored instructions for one or more aspects of this technology, as described and illustrated by way of the embodiments herein, although the processor(s) 22 could execute other numbers and types of programmed instructions. The processor(s) 22 in each of the storage node computing devices 14(1)-14(n) may include one or more central processing units or general purpose processors with one or more processing cores, for example.

The memory 24 of each of the storage node computing devices 14(1)-14(n) in this particular example may include any of various forms of read only memory (ROM), random access memory (RAM), Flash memory, non-volatile, or volatile memory, or the like, or a combination of such devices for example. In this example, the memory 24 includes a hardware resource pool 32, hardware allocation table 34, monitoring module 36, and storage virtual machines 38(1)-38(n), although other modules can also be included in the memory 23 in other examples.

The hardware resource pool 32 is generated based on hardware resource data for each of the storage node computing devices 14(1)-14(n) and includes an indication of the available hardware resources in the storage cluster computing apparatus 12. In one example. the hardware resource pool 32 is managed by way of example only the primary storage node computing device 14(1) and the information stored therein is imported, in real-time or periodically, by the secondary storage node computing devices 14(2)-14(n) into respective copies of the hardware resource pool 32, although other configurations can also be used. In this example, the primary storage node computing device 14(1) can generate or populate the hardware resource pool based on hardware resource data (e.g., data regarding processors, memory, cache, non-volatile memory, disk storage capacity, or network interface controllers) obtained from the secondary storage node computing devices 14(2)-14(n), as described and illustrated in more detail later.

The hardware allocation table 34 storage data regarding the portion of the hardware resources allocated to the storage virtual machines 38(1)-38(n) hosted by the each of the storage node computing devices 14(1)-14(n) of the storage cluster computing apparatus 12 for use by the storage virtual machines 138(1)-38(n) in servicing requests from the client devices 18(1)-18(n). The hardware allocation table 34 can reflect an allocation of the hardware resources of the hardware resource pool 32, as well as modifications made to the allocation based on monitoring of utilization of the hardware resources by the storage virtual machines 38(1)-38(n) and the application of dynamic and static policies, as described and illustrated in more detail later.

In one example, the hardware allocation table 34 is managed by the primary storage node computing device 14(1) and the information stored therein is imported by the secondary storage node computing devices 14(2)-14(n) into respective copies of the hardware allocation table 34, in real-time or periodically, although other configurations can also be used. The hardware allocation table 34 can be used by the storage node computing devices 14(1)-14(n) to determine whether one of the storage virtual machines 38(1)-38(n) is over-utilizing or under-utilizing hardware resources and should be allocated a greater or lesser proportion of the hardware resources of the hardware resource pool 32, as described and illustrated in more detail later.

The monitoring module 36 in this example monitors utilization of the hardware resources of the storage cluster computing apparatus by the storage virtual machines 38(1)-38(n). The monitoring module 36 can generate an alert or other communication, for example, when observed utilization of one or more of the hardware resources allocated to one of the storage virtual machines 38(1)-38(n), as indicated in the hardware allocation table 34, exceeds a maximum threshold level or is below a minimum threshold level. The primary storage node computing device 14(1) in this example can process such communications by applying one or more dynamic or static policies for the one of the storage virtual machines 38(1)-38(n) in order to determine whether to adjust the allocation of the one or more of the hardware resources for the one of the storage virtual machines 38(1)-38(n), as described and illustrated in more detail later.

The storage virtual machines 38(1)-38(n) execute applications that manage the storage of data on, and retrieval of data from, volumes hosted by the storage node computing devices 14(1)-14(n) of the storage cluster computing apparatus 12 on behalf of the client devices 18(1)-18(n). The volumes can be hosted on the storage device(s) 26, which can include optical disk-based storage or any other type of storage suitable for storing files or objects in storage volumes for short or long term retention, for example. In other examples, one or more disk shelves with storage devices can be included in the storage cluster computing apparatus 12 or elsewhere in the network environment 10 in separate or dedicated storage server(s), for example.

The communication interface 28 of the one of the storage node computing devices 14(1)-14(n) in this example operatively couples and communicates between the one of the storage node computing devices 14(1)-14(n) and the client devices 18(1)-18(n) via the communication network(s) 20, although other types and numbers of communication networks or systems with other types and numbers of connections and configurations to other devices and elements can also be used.

By way of example only, the communication network(s) 20 can use TCP/IP over Ethernet and industry-standard protocols, including NFS, CIFS, SOAP, XML, LDAP, and SNMP, although other types and numbers of communication networks, can be used. The communication network(s) 20 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

Referring back to FIG. 1, the one of the storage node computing devices 14(1)-14(n) receives requests to write and read data from the client devices 18(1)-18(n) via the communication network(s) 20 and communicates with one or more other of the storage node computing devices 14(1)-14(n) in order to service the requests. Accordingly, each of the client devices 18(1)-18(n) includes a processor, a memory, a communication interface, and, optionally, an input device and a display device, which are coupled together by a bus or other communication link, although the client devices 18(1)-18(n) can have other types and numbers of components or other elements. One or more of the client devices 18(1)-18(n) may be, for example, a conventional personal computer, a server hosting application(s) that utilize back-end storage provided by the storage cluster computing apparatus 12, or any other type of processing and/or computing device.

The administrator device 19 in this example is used by an storage cluster or storage virtual machine administrator to change configuration settings or policies for the storage virtual machines 38(1)-38(n), deploy new storage virtual machines, and add new storage node computing devices to the storage cluster computing apparatus 12, as described and illustrated in more detail later. The administrator device 19 can also be used to manually allocate and deallocate hardware resources for one or more of the storage virtual machines 38(1)-38(n) with static policies, as well as manage response to unavailability of sufficient hardware resources to support the overall utilization by the storage virtual machines 38(1)-38(n).

Accordingly, the administrator device 19 can include a processor, a memory, a communication interface, an input device, and a display device, which are coupled together by a bus or other communication link, although the administrator device 19 can also have other types and numbers of components. The administrator device 19 can be a conventional personal computer or any other type of network-connected computing device.

Although examples of the storage node computing devices 14(1)-14(n), client devices 18(1)-18(n), and administrator device 19 are described herein, it is to be understood that the devices and systems of the examples described herein are for exemplary purposes, as many variations of the specific hardware and software used to implement the examples are possible, as will be appreciated by those skilled in the relevant art(s). In addition, two or more computing systems or devices can be substituted for any one of the systems in any embodiment of the examples.

The examples also may be embodied as one or more non-transitory computer readable media having instructions stored thereon for one or more aspects of the present technology, as described and illustrated by way of the examples herein, which when executed by a processor, cause the processor to carry out the steps necessary to implement the methods of this technology, as described and illustrated with the examples herein.

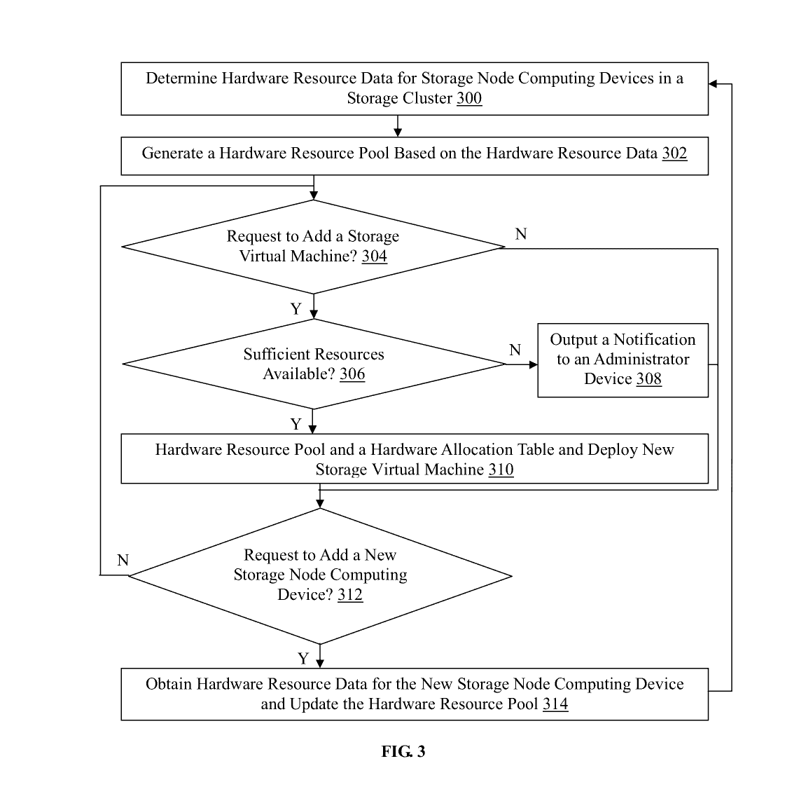

An exemplary method for allocating hardware resources in the storage cluster computing apparatus 12 will now be described with reference to FIGS. 1-5. Referring more specifically to FIG. 3, a method for initializing the storage cluster computing apparatus 12 and managing the deployment of storage virtual machines and addition of storage node computing devices is illustrated. In step 300 in this example, the storage cluster computing apparatus 12 obtains hardware resource data for the storage node computing devices 14(1)-14(n) of the storage cluster computing apparatus 12.

In this particular example, the primary storage node computing device 14(1) can determine the hardware resource data for its associated hardware and can retrieve hardware resource data from the secondary storage node computing devices 14(2)-14(n) for the hardware resources associated with the secondary storage node computing devices 14(2)-14(n). Any of the storage node computing devices 14(1)-14(n) can determine the hardware resource data using utilities, command prompts, or another integration or interface made available by the operating system, for example, although other methods for determining the hardware resource data can also be used. The hardware resource data for each of the storage node computing devices 14(1)-14(n) can include information regarding the number and characteristics (e.g., speed) of the processor(s), the size of the memory, cache, non-volatile memory, or storage disk(s), or the number of network interface controller(s), for example, although hardware resource data can also be obtained for other types and numbers of hardware resources of the storage node computing devices 14(1)-14(n).

In step 302, the storage cluster computing apparatus generates the hardware resource pool 32 based on the hardware resource data. Accordingly, the primary storage node computing device 14(1) in this example can aggregate the hardware resource data obtained for each of the storage node computing devices 14(1)-14(n) into the hardware resource pool 32. The hardware resource pool 32 can be maintained as a table, database, or other data storage structure, for example. Optionally, the hardware resource pool 32 of the primary storage node computing device 14(1) can be imported by the secondary storage node computing devices 14(2)-14(n) via polling or other type of real-time or periodic updating, for example.

In step 304, the storage cluster computing apparatus determines whether a request to add a new storage virtual machine, such as a new one of the storage virtual machines 38(1)-38(n), has been received. A request to add one of the storage virtual machines 38(1)-38(n) can be received from the administrator device 19, for example, and by any of the storage node computing devices 14(1)-14(n). Optionally, the request to add the new one of the storage virtual machines 38(1)-38(n) includes an indication of hardware resources (e.g., a size of cache or number of processors) that are required to be allocated to the new one of the storage virtual machines 38(1)-38(n). If the storage cluster computing apparatus 12 determines that a request to add a new storage virtual machine has been received, then the Yes branch is taken to step 306.

In step 306, the storage cluster computing apparatus 12 determines whether there are sufficient resources available to satisfy the request received in step 304. The hardware resources required to satisfy the request can be indicated in the request or, alternatively, a set of required hardware resources can be determined based on a stored policy, for example, and other methods can also be used to determine the hardware resource requirements of the new one of the storage virtual machines 38(1)-38(n).

In order to determine whether sufficient resources are available, the one of the storage node computing devices 14(1)-14(n) of the storage cluster computing apparatus 12 that received the request in step 304 can query the hardware resource pool 32 to determine whether there are enough available, and currently unallocated, hardware resources to satisfy the hardware resource requirements of the new one of the storage virtual machines 38(1)-38(n). In this example, the hardware resources indicated as currently included in the hardware resource pool 32 are available for allocation and have not yet been allocated to any of the storage virtual machines 38(1)-38(n).

In this particular example, if the request to add a new one of the storage virtual machines 38(1)-38(n) is received by one of the secondary storage node computing devices 14(2)-14(n), then the one of the secondary storage node computing devices 14(2)-14(n) can query the local, imported copy of the hardware resource pool 32 to determine whether sufficient resources are available to satisfy the requirements of the new one of the storage virtual machines 38(1)-38(n). In other examples, the one of the secondary storage node computing devices 14(2)-14(n) that received the request to add the new one of the storage virtual machines 38(1)-38(n) can query the hardware resource pool 32 hosted by the primary storage node computing device 14(1) to determine whether sufficient resources are available to satisfy the requirements of the new one of the storage virtual machines 38(1)-38(n). Other methods of determining whether sufficient resources are available to satisfy the requirements of the new one of the storage virtual machines 38(1)-38(n) based on the hardware resource pool 32 can also be used.

If the storage cluster computing apparatus 12 determines in step 306 that sufficient resources are not available to satisfy the hardware resource requirements of the new one of the storage virtual machines 38(1)-38(n), then the No branch is taken to step 308. In step 308, the one of the storage node computing devices 14(1)-14(n) that received the request to add the new one of the storage virtual machines 38(1)-38(n) outputs a notification to the administrator device 19 indicating that insufficient hardware resources are available for allocation to the new one of the storage virtual machines 38(1)-38(n). Optionally, the notification can include an indication of the hardware resource type(s) for which insufficient resources are available. In response, a user of the administrator device 19 can resubmit a request to add the new one of the storage virtual machines 38(1)-38(n) that indicates fewer required hardware resources for at least one hardware resource type, bring a new one of the storage node computing devices 14(1)-14(n) online in the storage cluster computing apparatus 12, or take any other action.

However, referring back to step 306, if the storage cluster computing apparatus 12 determines that sufficient resources are available to satisfy the hardware resource requirements of the new one of the storage virtual machines 38(1)-38(n), then the Yes branch is taken to step 310. In step 310, the storage cluster computing apparatus 12 updates the hardware resource pool 32 and the hardware allocation table 34. The hardware resource pool 32 is updated to remove hardware resources corresponding to the hardware resources required by the new one of the storage virtual machines 38(1)-38(n). Additionally, the hardware allocation table 34 is updated to reflect the allocation of the hardware resources to the new one of the storage virtual machines 38(1)-38(n). As with the hardware resource pool 32, the hardware allocation table 34 can be maintained by the primary storage node computing device 14(1) and optionally imported periodically or substantially in real-time by the secondary stores node computing device 14(2)-14(n).

Accordingly, in this particular example, if the request to add the new one of the storage virtual machines 38(1)-38(n) is received and processed by one of the secondary storage node computing devices 14(2)-14(n), the one of the secondary storage node computing devices 14(2)-14(n) can communicate with the primary node computing device 14(1) in order to update the hardware resource pool 32 and the hardware allocation table 34. Other methods for updating the hardware resource pool 32 or the hardware allocation table 34 can also be used. Additionally, in step 308, the one of the storage node computing devices 14(1)-14(n) that received the request to add the new one of the storage virtual machines 38(1)-38(n) deploys the new one of the storage virtual machines 38(1)-38(n) in an application layer.

Subsequent to deploying the new one of the storage virtual machines 38(1)-38(n), or outputting a notification to the administrator device in step 308, or if the storage cluster computing apparatus 12 determines in step 304 that a request to add a new one of the storage virtual machines 38(1)-38(n) has not been received and the No branch is taken, the storage cluster computing apparatus 12 proceeds to step 312. In step 312, the storage cluster computing apparatus 12 determines whether a request has been received to add a new one of the storage node computing devices 14(1)-14(n), such as from the administrator device 19. If the storage cluster computing apparatus 12 determines that a request to add a new one of the storage node computing devices 14(1)-14(n) has been received, then the Yes branch is taken to step 314.

In step 314, the storage cluster computing apparatus 12 obtains hardware resource data for the new one of the storage node computing devices 14(1)-14(n) and updates the hardware resource pool 32 accordingly. The hardware resource data can be obtained for the new one of the storage node computing devices 14(1)-14(n) as described and illustrated earlier with reference to step 300. Additionally, the hardware resource pool 32 can be updated as described and illustrated earlier with reference to step 310.

Accordingly, the new one of the storage node computing devices 14(1)-14(n) can be added to the storage cluster computing apparatus 12 relatively seamlessly and without downtime. Additionally, the associated hardware resources of the new one of the storage node computing devices 14(1)-14(n) can be integrated and used to determine the efficiency of the hardware resource utilization across the storage cluster computing apparatus 12, as described and illustrated in more detail later.

Referring back to step 312, if the storage cluster computing apparatus 12 determines that a request to add a new one of the storage node computing devices 14(1)-14(n) has not been received, then the No branch is taken back to step 304. Accordingly, once initialized, the storage cluster computing apparatus 12 essentially waits to receive either a request to add a new one of the storage virtual machines 38(1)-38(n) or a new one of the storage node computing devices 14(1)-14(n).

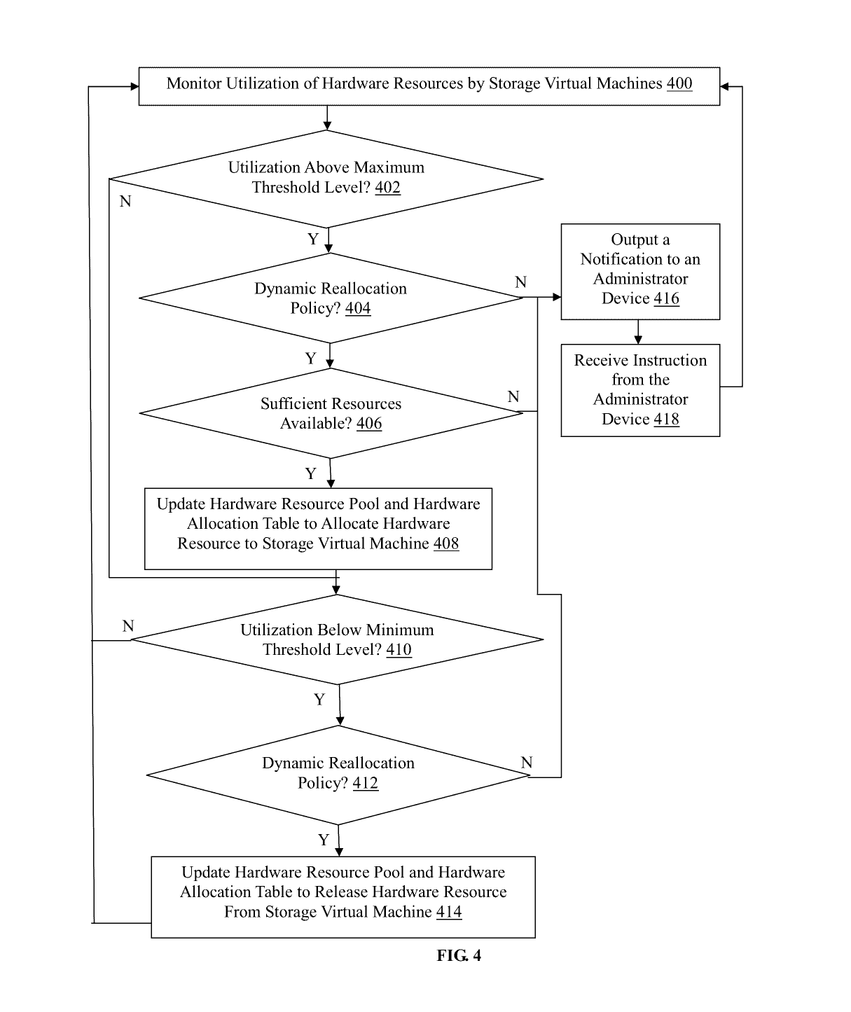

Referring more specifically to FIG. 4, a method for dynamically allocating storage cluster hardware resources is illustrated. In step 400 in this example, the storage cluster computing apparatus 12 monitors utilization of hardware resources by the storage virtual machines 38(1)-38(n). Accordingly, each of the storage node computing devices 14(1)-14(n) can monitor one or more of the storage virtual machine(s) 38(1)-38(n) hosted thereby to determine the level of utilization of hardware resources corresponding to the types of hardware resources maintained in the hardware resource pool 32.

In step 402, the storage cluster computing apparatus 12 determines whether a maximum threshold level of hardware utilization has been exceeded for at least one type of hardware resource for one of the storage virtual machines 38(1)-38(n). The threshold levels can be included in a policy established by an administrator for one or more of the storage virtual machines 38(1)-38(n) or of the storage cluster computing apparatus 12, for example. Additionally, the policies can be enforced by storage node computing devices 14(1)-14(n) hosting respective ones of the storage virtual machines 38(1)-38(n).

The thresholds analyzed in step 402, and/or in step 410 as described and illustrated in more detail later, can be based on percentages of the allocated amount of hardware resources, as indicated in the hardware resource allocation table 34, for one or more of the types of hardware resources. For example, a maximum threshold level may be 90% of the allocated amount of one type of hardware resource, although any other percentages, types of thresholds, and policies can also be used. If the storage cluster computing apparatus 12 determines that a maximum threshold level has been exceeded, then the Yes branch is taken to step 404 and the storage cluster computing apparatus 12 continues monitoring the storage virtual machines 38(1)-38(n) as described and illustrated earlier.

In step 404, the storage cluster computing apparatus 12 determines whether the one of the storage virtual machines 38(1)-38(n) has an associated dynamic reallocation policy. In this particular example, the storage virtual machines 38(1)-38(n) are associated with static or dynamic policies that define the treatment of the corresponding hardware resource allocation in the event an over-utilization or an under-utilization of one of the types of hardware resources is detected.

Optionally, the policies can be established by an administrator and can be received from the administrator device 19 along with a request to add one of the storage virtual machines 38(1)-38(n) received in step 304 of FIG. 3, although other methods for responding to a detected over-utilization or under-utilization of one of the types of hardware resources can also be used. Accordingly, if the storage cluster computing apparatus 12 determines in step 404 that the one of the storage virtual machines 38(1)-38(n) has an associated dynamic policy, then the Yes branch is taken to step 406.

In step 406, the storage cluster computing apparatus 12 determines whether sufficient hardware resources are available in the hardware resource pool 32 for allocation to the one of the storage virtual machines 38(1)-38(n). The amount of hardware resources required can depend on the amount of over-utilization by the one of the storage virtual machines 38(1)-38(n) or the type of the one of the virtual machines 38(1)-38(n), for example, and can be established in the dynamic reallocation policy.

In one example, production, staging, or test ones of the storage virtual machines 38(1)-38(n) can be prioritized or deprioritized based on business requirements and, accordingly, can require more or fewer hardware resources in a dynamic reallocation. Other types and numbers of parameters and other methods for determining the sufficiency of the available resources to satisfy a reallocation to the one of the storage virtual machines 38(1)-38(n) in response to a detected over-utilization of a type of hardware resources can also be used.

Accordingly, if the storage cluster computing apparatus 12 determines that sufficient hardware resources are available in the hardware resource pool 32 for allocation to the one of the storage virtual machines 38(1)-38(n), then the Yes branch is taken to step 408. In step 408, the storage cluster computing apparatus 12 updates the hardware resource pool 32 and the hardware allocation table 34 to allocate additional hardware resources of one or more types of hardware resources to the one of the storage virtual machines 38(1)-38(n), as described and illustrated in more detail earlier with reference to step 310 of FIG. 3, for example. Accordingly, in iterations in which the storage cluster computing apparatus 12 determines an over-utilization is detected, the storage cluster computing apparatus 12 updates the hardware resource pool 32 to remove an amount of hardware resources for one of the hardware resource types from the hardware resource pool 32 and updates the hardware allocation table 34 to allocate the amount of hardware resources for the one of the hardware resource types to the one of the storage virtual machines 38(1)-38(n).

Subsequent to updating the hardware resource pool 32 and the hardware allocation table 34, or if the storage cluster computing apparatus 12 determines in step 402 that utilization above a maximum threshold level has not been detected and the No branch is taken, then the storage cluster computing apparatus 12 proceeds to step 410. In step 410, the storage cluster computing apparatus 12 determines whether utilization of one or more types of hardware resources by one of the storage virtual machines 38(1)-38(n) below a minimum threshold level has been detected. The threshold minimum level can be established as described and illustrated in more detail earlier with reference to step 402, for example.

Accordingly, if the storage cluster computing apparatus 12 determines in step 410 that utilization of one or more types of hardware resources by one of the storage virtual machines 38(1)-38(n) below a minimum threshold level has been detected, then the Yes branch is taken to step 412. In step 412, the storage cluster computing apparatus 12 determines whether the one of the storage virtual machines 38(1)-38(n) has an associated dynamic reallocation policy, as described and illustrated earlier with reference to step 404. If the storage cluster computing apparatus 12 determines that the one of the storage virtual machines 38(1)-38(n) has an associated dynamic reallocation policy, then the Yes branch is taken to step 414.

In step 414, the storage cluster computing apparatus 12 updates the hardware resource pool 32 and the hardware allocation table 34 to release hardware resources of one or more types of hardware resources from the one of the storage virtual machines 38(1)-38(n), as described and illustrated in more detail earlier with reference to step 310 of FIG. 3 and step 408, for example. Accordingly, in iterations in which the storage cluster computing apparatus 12 determines an under-utilization is detected, the storage cluster computing apparatus 12 updates the hardware resource pool 32 to reflect the releasing of a portion of the previously allocated hardware resources for the one of the hardware resource types back to the hardware resource pool 32 from the one of the storage virtual machines 38(1)-38(n) and updates the hardware allocation table 34 to deallocate the amount of hardware resources for the one of the hardware resource types from the one of the storage virtual machines 38(1)-38(n). Subsequent to updating the hardware resource pool 32 and the hardware allocation table in step 414, the storage cluster computing apparatus 12 continues monitoring the storage virtual machines 38(1)-38(n) in step 400.

However, if the storage cluster computing apparatus 12 determines in step 404 or 412 that a dynamic policy is not associated with the one of the storage virtual machines 38(1)-38(n) and the No branch is taken, or if the storage cluster computing apparatus 12 determines in step 406 that sufficient hardware resources are not available in the hardware resource pool 32 for allocation to the one of the storage virtual machines 38(1)-38(n) and the No branch is taken, then the storage cluster computing apparatus proceeds to step 416. In step 416, the storage cluster computing apparatus 12 outputs a notification to the administrator device 19.

Optionally, the storage cluster computing apparatus 12 can automatically generate recommended action(s) that can be taken by an administrator and the notification can include the recommended action(s). The recommended action(s) can include allocating additional hardware resources to, or deallocating hardware resource from, the one of the storage virtual machines 38(1)-38(n) or adding a new one of the storage node computing devices 14(1)-14(n) to the storage cluster computing apparatus 12, for example, although other recommended actions can also be generated and included the notification output by the storage cluster computing apparatus 12 in step 416.

In step 418, the storage cluster computing apparatus 12 optionally receives instructions from the administrator device 19 in response to the notification output in step 412. In some examples, the storage cluster computing apparatus 12 may update the hardware resource pool 32 and hardware allocation table 34, as described and illustrated earlier with reference to steps 408 and 414, in response to the instructions. Subsequent to receiving the instructions, or during any of steps 402-418, the storage node computing devices 14(1)-14(n) of the storage cluster computing apparatus 12 continues to monitor utilization of the hardware resources by the storage virtual machines 38(1)-38(n) in step 400.

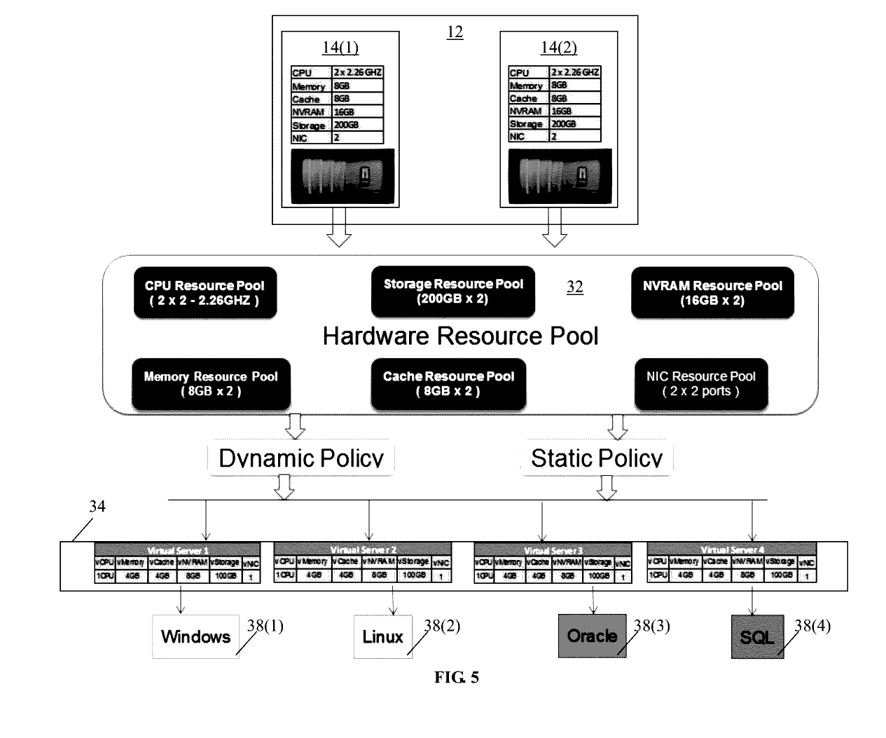

Referring more specifically to FIG. 5, a functional flow diagram of a method for allocating hardware resources in the storage cluster computing apparatus 12 is illustrated. In this example, the storage cluster computing apparatus 12 includes two storage node computing devices 14(1) and 14(2). The types of hardware resources included in the hardware resource pool 32 in this particular example include processors, memory, cache, non-volatile memory, storage memory (e.g., storage disks or drives, and network interface controllers.

Accordingly, the amount of the each of the types of hardware resources is aggregated into the hardware resource pool 32 that can be stored or maintained by one or more of the storage node computing devices 14(1) and 14(2). As part of an initialization, the hardware resources of the hardware resource pool 32 are allocated to storage virtual machines 38(1)-38(4) (referred to in FIG. 5 as virtual servers 1-4 and associated with different operating systems), as reflected in the hardware allocation table 34.

Over time, and based on monitoring by the storage node computing devices 14(1) and 14(2) of the hardware resource utilization of the storage virtual machines, dynamic and/or static reallocation policies are applied and the hardware resource pool 32 and hardware allocation table 34 are updated. The monitoring of the storage virtual machines 38(1)-38(4) and maintenance of the hardware resource pool 32 and hardware allocation table 34 facilitates more effective utilization of the hardware resources of the storage cluster computing apparatus 12.

In particular, with this technology hardware resources of a storage cluster computing apparatus can be dynamically allocated to storage virtual machines based on utilization, resulting in improved utilization of the hardware resources. Advantageously, the dynamical allocation can be based on policies that prioritize storage virtual machines based on business requirements in order to optimize utilization. Additionally, this technology allows a storage cluster computing apparatus to more effectively determine the availability of hardware resources to support new storage virtual machines based on associated requirements and current utilization of the deployed storage virtual machines.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

1. A method comprising:
obtaining, by a computing device, hardware resource data for a plurality of hardware resources of a plurality of storage node computing devices of a storage cluster and generating a hardware resource pool based on the hardware resource data;
updating, by the computing device, the hardware resource pool and a hardware allocation table based on an allocation of a portion of the hardware resources to each of a plurality of storage virtual machines;
determining, by the computing device, when a current utilization of one or more of the allocated portions of the hardware resources exceeds a threshold level for one or more of the storage virtual machines; and
updating, by the computing device, the hardware resource pool and the hardware allocation table to modify the one or more of the portions of the hardware resources allocated to the one or more of the storage virtual machines based on one or more attributes of the one or more of the storage virtual machines, when the determining indicates that the current utilization exceeds the threshold level.

2. The method of claim 1, further comprising:
determining, by the computing device, whether the one or more of the storage virtual machines a have an associated stored dynamic reallocation policy, when the determining indicates that the current utilization exceeds the threshold level;
outputting, by the computing device, a notification to an administrator computing device, the notification comprising a recommended action, when the determining indicates that the one or more of the storage virtual machines does not have an associated stored dynamic reallocation policy; and
performing, by the computing apparatus, the updating when the determining indicates that the one or more of the storage virtual machines a have an associated stored dynamic reallocation policy or upon receiving instructions to update the hardware resource pool from the administrator device in response to the notification.

3. The method of claim 1, further comprising:
receiving, by the computing device, a request to add a new storage node computing device to the storage cluster;
determining, by the computing device, additional hardware resource data for a set of hardware resources of the new storage node computing device; and
updating, by the computing device, the hardware resource pool based on the additional hardware resource data for the set of hardware resources for the new storage node computing device.

4. The method of claim 1, further comprising:
receiving, by the computing device, a request to add a new storage virtual machine to the storage cluster, the request comprising an indication of requested hardware resource requirements;
determining, by the computing device, an availability of the hardware resources based on the hardware resource pool, and when the request can be satisfied based on the availability; and
updating, by the computing device, the hardware resource pool and the hardware resource table to allocate the requested hardware resource requirements to the new storage virtual machine, and deploying the new storage virtual machine in an application layer, when the determining indicates the request can be satisfied based on the availability.

5. The method of claim 1, further comprising outputting, by the computing device, a notification to an administrator device, when the determining indicates that the current utilization does not exceed the threshold level.

6. A non-transitory machine readable medium having stored thereon instructions for performing a method comprising executable code which when executed by at least one machine, causes the machine to:
obtain hardware resource data for a plurality of hardware resources of a plurality of storage node computing devices of a storage cluster and generate a hardware resource pool based on the hardware resource data;
update the hardware resource pool and a hardware allocation table based on an allocation of a portion of the hardware resources to each of a plurality of storage virtual machines;
determine when a current utilization of one or more of the allocated portions of the hardware resources exceeds a threshold level for one or more of the storage virtual machines; and
update the hardware resource pool and the hardware allocation table to modify the one or more of the portions of the hardware resources allocated to the one or more of the storage virtual machines, when the determining indicates that the current utilization exceeds the threshold level.

7. The non-transitory computer readable medium of claim 6, wherein the machine executable code when executed by the machine further causes the machine to:
determine whether the one or more of the storage virtual machines have an associated stored dynamic reallocation policy, when the determining indicates that the current utilization exceeds the threshold level;
output a notification to an administrator computing device, the notification comprising a recommended action, when the determining indicates that the one or more of the storage virtual machines does not have an associated stored dynamic reallocation policy; and
perform the updating when the determining indicates that the one or more of the storage virtual machines have an associated stored dynamic reallocation policy or upon receiving instructions to update the hardware resource pool from the administrator device in response to the notification.

8. The non-transitory computer readable medium of claim 6, wherein the machine executable code when executed by the machine further causes the machine to:
receive a request to add a new storage node computing device to the storage cluster;
determine additional hardware resource data for a set of hardware resources of the new storage node computing device; and
update the hardware resource pool based on the additional hardware resource data for the set of hardware resources for the new storage node computing device.

9. The non-transitory computer readable medium of claim 6, wherein the machine executable code when executed by the machine further causes the machine to:
receive a request to add a new storage virtual machine to the storage cluster, the request comprising an indication of requested hardware resource requirements;
determine an availability of the hardware resources based on the hardware resource pool, and when the request can be satisfied based on the availability; and
update the hardware allocation table to allocate the requested hardware resource requirements to the new storage virtual machine and deploy the new storage virtual machine in an application layer, when the determining indicates the request can be satisfied based on the availability.

10. The non-transitory computer readable medium of claim 6, wherein the machine executable code when executed by the machine further causes the machine to output a notification to an administrator device, when the determining indicates that the current utilization does not exceed the threshold level.

11. A computing device, comprising:
a memory containing machine readable medium comprising machine executable code having stored thereon instructions for performing a method of allocating storage cluster hardware resources; and
a processor coupled to the memory, the processor configured to execute the machine executable code to cause the processor to:
obtain hardware resource data for a plurality of hardware resources of a plurality of storage node computing devices of a storage cluster and generate a hardware resource pool based on the hardware resource data;
updating the hardware resource pool and a hardware allocation table based on an allocation of a portion of the hardware resources to each of a plurality of storage virtual machines;
determine when a current utilization of one or more of the allocated portions of the hardware resources exceeds a threshold level for one or more of the storage virtual machines; and
update the hardware resource pool and the hardware allocation table to modify the one or more of the portions of the hardware resources allocated to the one or more of the storage virtual machines, when the determining indicates that the current utilization exceeds the threshold level.

12. The computing device of claim 11, wherein the processor is further configured to execute the machine executable code to further cause the processor to:
determine whether the one or more of the storage virtual machines have an associated stored dynamic reallocation policy, when the determining indicates that the current utilization exceeds the threshold level;
output a notification to an administrator computing device, the notification comprising a recommended action, when the determining indicates that the one or more of the storage virtual machines does not have an associated stored dynamic reallocation policy; and
perform the updating when the determining indicates that the one or more of the storage virtual machines have an associated stored dynamic reallocation policy or upon receiving instructions to update the hardware resource pool from the administrator device in response to the notification.

13. The computing device of claim 11, wherein the processor is further configured to execute the machine executable code to further cause the processor to:
receive a request to add a new storage node computing device to the storage cluster;
determine additional hardware resource data for a set of hardware resources of the new storage node computing device; and
update the hardware resource pool based on the additional hardware resource data for the set of hardware resources for the new storage node computing device.

14. The computing device of claim 11, wherein the processor is further configured to execute the machine executable code to further cause the processor to:
receive a request to add a new storage virtual machine to the storage cluster, the request comprising an indication of requested hardware resource requirements;
determine an availability of the hardware resources based on the hardware resource pool, and when the request can be satisfied based on the availability; and
update the hardware allocation table to allocate the requested hardware resource requirements to the new storage virtual machine, and deploying the new storage virtual machine in an application layer, when the determining indicates the request can be satisfied based on the availability.

15. The computing device of claim 11, wherein the processor is further configured to execute the machine executable code to further cause the processor to output a notification to an administrator device, when the determining indicates that the current utilization does not exceed the threshold level.
